(19) United States
(12) Patent Application Publication
(10) Pub. No.: US 2026/0281027 A1
(43) Pub. Date: Sep. 17, 2026

(54) REDUCING PACKET LOSS ASSOCIATED WITH ENDPOINT LOCATION CHANGES

(71) Applicant: Red Hat, Inc., Raleigh, NC (US)

(72) Inventors: Michael S. Tsirkin, Ra'anana (IL); Ilan Amnon, Ra'anana (IL)

(73) Assignee: Red Hat, Inc., Raleigh, NC (US)

(21) Appl. No.: 19/078,527

(22) Filed: Mar. 13, 2025

(51) Int. Cl. H04L 45/24; H04L 41/0604; H04L 45/76

(52) U.S. Cl. CPC H04L 45/24; H04L 41/0627; H04L 45/76

(57) ABSTRACT

Packet loss associated with endpoint location changes can be reduced using the technique described herein. In one example, a system can receive a data packet from a sending device, where the data packet is intended for a destination endpoint. The system can determine that a location of the destination endpoint changed from a first location to a second location. This location change might normally result in loss of the data packet. But, based on receiving the data packet and determining that the location of the destination endpoint changed, the system can generate a notification indicative of the location change. The system can then transmit the notification to the sending device. Based on this notification, the sending device can retransmit the packet’s content to the second location to prevent data loss.

### TECHNICAL FIELD

The present disclosure relates generally to reducing packet loss in a computer network. More specifically, but not by way of limitation, this disclosure relates to reducing packet loss that may arise in a computer network as a result of endpoint location changes.

### BACKGROUND

A computer network can have a variety of networking devices that help direct packet flow to destination endpoints. For example, a computer network can include networking devices such as hubs, routers, switches, bridges, and/or gateways that help direct packets through the network to destination endpoints. Over time, a destination endpoint may change locations. For example, the destination endpoint’s physical location and/or logical location in the network can change. When a destination endpoint’s location changes, the change may be announced to the network devices and other devices in the network, so that they can update their configurations to account for the location change. For example, an announcement packet may be propagated through the network to notify the devices in the network of the location change. Upon receiving the announcement packet, the devices can update their configurations to accommodate the location change, so that packets intended for the destination endpoint are sent to the correct location.

### BRIEF DESCRIPTION OF THE DRAWINGS

FIG. 1 shows a block diagram of an example of a system for reducing packet loss associated with endpoint location changes according to some aspects of the present disclosure.

FIG. 2 shows a flowchart of a process implemented by a device for reducing packet loss associated with endpoint location changes according to some aspects of the present disclosure.

FIG. 3 shows a flowchart of an example of a process implemented by a sending device for reducing packet loss associated with endpoint location changes according to some aspects of the present disclosure.

FIG. 4 shows a flowchart of an example of a process for storing packet content and transmitting the packet content according to some aspects of the present disclosure.

FIG. 5 shows a flowchart of another example of a process implemented by a sending device for reducing packet loss associated with endpoint location changes according to some aspects of the present disclosure.

FIG. 6 shows a block diagram of an example of a system for reducing packet loss associated with endpoint location changes according to some aspects of the present disclosure.

FIG. 7 shows a flowchart of a process for reducing packet loss associated with endpoint location changes according to some aspects of the present disclosure.

### DETAILED DESCRIPTION

A computer network can include various devices that transmit data packets to designated destination endpoints. Over time, the logical and/or physical location of a destination endpoint may change. When such a change occurs, the location change is typically announced to some or all devices in the network, so that the devices can update themselves to account for the location change. These announcements help ensure that data packets intended for the destination endpoint are sent to the correct location. However, the propagation of such announcements across the network can be slow, and in some cases, the announcements may be lost. If a device does not receive a location change announcement in time, it may inadvertently send a data packet to the endpoint’s previous location. For instance, if a sending device transmits a data packet before receiving the announcement, the data packet may be directed to the endpoint’s old address, leading to packet loss or failure in delivery. This issue is particularly pronounced in large networks with thousands of devices or in systems where destination endpoints frequently change locations, such as mobile phone networks, where packet loss can become significant.

Some examples of the present disclosure can overcome one or more of the abovementioned problems by notifying the sending device when it attempts to transmit a data packet to an outdated destination address. For example, a sending device may transmit a data packet intended for a destination endpoint, before receiving a location change announcement for that destination endpoint, potentially due to delays in the announcement’s propagation or the announcement being lost. As a result, the data packet may contain an outdated destination address (e.g., an old IP address) that no longer corresponds to the current location of the endpoint. Before reaching its intended destination, the data packet may be received by a device in the network, such as a router or switch, which has already received the location change announcement. Upon detecting that the destination address in the data packet is outdated, the device can send a notification to the sending device. In response, the sending device can pause further transmissions to the endpoint, await the location change announcement, determine the correct address (e.g., the new IP address) for the destination endpoint from the announcement, and retransmit the data packet to the updated address. By doing so, the system ensures that the packet reaches its intended destination and avoids being lost.

As one particular example, the destination endpoint can be a virtual machine (VM) that was migrated from a first host device to a second host device. In a conventional scenario, if a sending device inadvertently transmits a data packet intended for the virtual machine to the first host device (e.g., because the sending device has not yet received the location change announcement), the first host device would simply drop the data packet. The data packet would thus be lost, and the sending machine may never know that the communication failed. But in some examples described herein, the first host device can transmit a notification to the sending device indicating that the virtual machine changed locations. The first host device may also include in the notification at least some of the packet’s content, such as the header, payload, and/or trailer of the data packet. For instance, the first host device may encapsulate the data packet in the notification. Based on receiving the notification, the sending device can extract the packet’s content from the notification and wait until it receives the location change announcement, which can provide the new address of the virtual machine. Once the sending device finally receives the location change announcement, the sending device can determine the new address of the virtual machine based on the announcement. The sending device can then retransmit the extracted content to the virtual machine at its new address – e.g., as a new data packet intended for the new address of the virtual machine. As a result, the packet content can eventually make it to its intended destination, rather than being lost.

These illustrative examples are given to introduce the reader to the general subject matter discussed here and are not intended to limit the scope of the disclosed concepts. The following sections describe various additional features and examples with reference to the drawings in which like numerals indicate like elements but, like the illustrative examples, should not be used to limit the present disclosure.

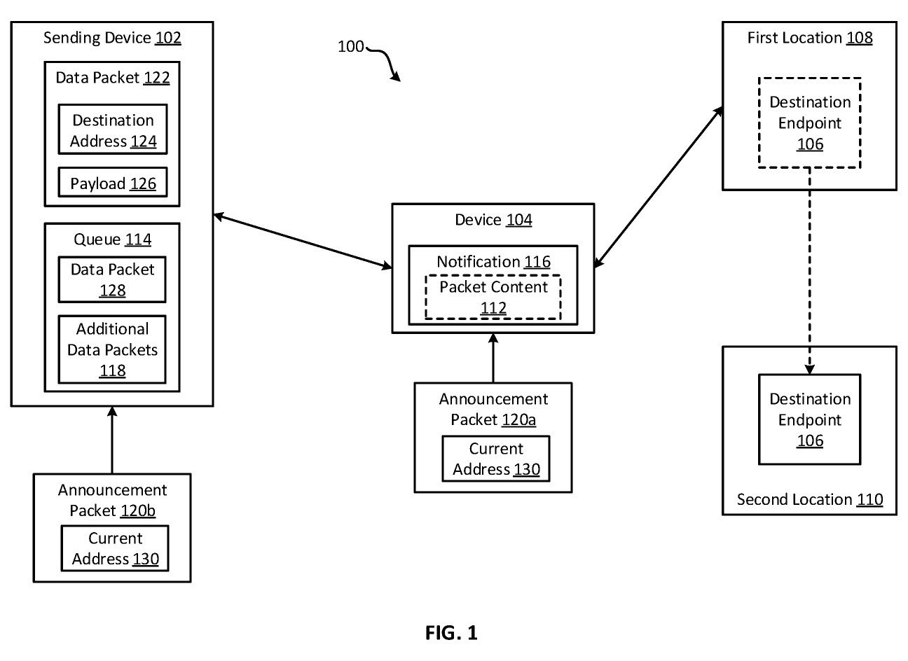

FIG. 1 shows a block diagram of an example of a system 100 for reducing packet loss associated with endpoint location changes according to some aspects of the present disclosure. The system 100 includes a computer network containing a sending device 102 and a destination endpoint 106. The sending device 102 is a physical device, such as a server, desktop computer, laptop computer, sensor device, Internet of Things (IOT) device, handheld device (e.g., a mobile phone, tablet, or e-reader), or wearable device such as a smart watch or smart glasses. The destination endpoint 106 may also be a physical device. Alternatively, the destination endpoint 106 may be a virtual machine, a container, or a software application. As used herein, a “container” can refer to a relatively isolated virtual environment that is deployed from an image file using a container engine, such as Docker®.

The sending device 102 may wish to send a data packet 122 to the destination endpoint 106. The data packet 122 can include a destination address 124 for the destination endpoint 106. One example of the destination address 124 can be an Internet Protocol (IP) address. The destination address 124 may be included in the header of the data packet 122. The data packet 122 also includes a payload 126 and, optionally, a trailer to verify the integrity of the transmitted data.

Before the sending device 102 transmits the data packet 122 to the destination endpoint 106, the location of the destination endpoint 106 may change. For example, the destination endpoint 106 may change from a first location 108 to a second location 110. The first location 108 and second location 110 may be logical locations in the computer network or physical locations in real space. For example, the destination endpoint 106 can be a mobile device (e.g., a mobile phone, laptop computer, tablet, etc.) that physically travels from the first location 108 to the second location 110, in which case the first location 108 and the second location 110 can be physical locations. As another example, the destination endpoint 106 can be a virtual machine or container that is migrated from a first host device to a second host device, in which case the first location 108 can be the first host device and the second location 110 can be the second host device. The first host device and second host device may reside at different logical locations in the computer network and/or physical locations in real space.

Based on the destination endpoint 106 changing location, the computer network may transmit one or more announcement packets 120a-b (collectively referred to as announcement packets 120). For example, if the destination endpoint 106 is a physical device, the destination endpoint 106 may itself transmit one or more of the announcement packets 120. As another example, if the destination endpoint 106 is software (e.g., a virtual machine, container, or application), the destination endpoint 106 or its new host device may transmit one or more of the announcement packets 120. In either case, the announcement packets 120 may be transmitted in response to the location change. The announcement packets 120 may also include the new destination address for the destination endpoint 106 at the second location 110.

The announcement packets 120 may take time to propagate through all the various devices in the computer network. Eventually, an announcement packet 120a may reach a device 104 in the computer network. The device 104 may be a networking device, in some examples. The device 104 is different from the sending device 102 and the destination endpoint 106.

In some examples, the device 104 may be the first location 108 at which the destination endpoint 106 previously resided prior to the location change. For instance, the device 104 may be the host device at which the destination endpoint 106 (e.g., a virtual machine or container) resided prior to a migration. In other examples, the device 104 may be an intermediary device that is logically positioned between (i) the sending device 102 and (ii) the first location 108 and/or the second location 110. For example, the device 104 may be logically positioned between the sending device 102 and the first location 108. Additionally or alternatively, the device 104 may be logically positioned between the sending device 102 and the second location 110. Based on the announcement packet 120a, the device 104 can determine that the destination endpoint 106 changed locations. The device 104 may also determine the current address 130 for the destination endpoint 106, for example by communicating with the destination endpoint 106 or by extracting that information from the announcement packet 120a. One example of the current address 130 may be a current IP address associated with the destination endpoint 106.

As noted above, the sending device 102 can generate the data packet 122 and may send the data packet 122 before it becomes aware of the destination endpoint’s 106 location change. The data packet 122 may propagate to through the computer network and eventually be received by the device 104. The device 104 can extract the destination address 124 from the data packet 122, compare the destination address 124 to the current address 130 of the destination endpoint 106, and if the addresses do not match, determine that the data packet 122 destination address is outdated. In response, the device 104 can generate a notification 116 indicating that the destination endpoint 106 changed locations. The device 104 may include the current address 130 of the destination endpoint 106 in the notification 116. In some examples, the device 104 can may also extract at least some of the content from the data packet 122, such as the payload 126, and incorporate the packet content 112 into the notification 116. For instance, the device 104 can generate the notification 116 as a second data packet that encapsulates some or all of the first data packet 122 from the sending device 102. The device 104 can then transmit the notification 116 to the sending device 102. The device 104 may also refrain from forwarding the data packet 122 to any other devices in the computer network and may discard the data packet 122.

The sending device 102 can receive the notification 116 and, based on the notification 116, determine that the destination address 124 that it previously used is outdated. So, the sending device 102 may refrain from sending one or more additional data packets 118 to the destination endpoint 106 at least until it determines the current address 130 for the destination endpoint 106. During this interim period, the sending device 102 may store those one or more additional data packets 118 in a queue 114. This can prevent the additional data packets 118 from being lost.

In some examples, the sending device 102 may also extract the packet content 112 from the notification 116. The sending device 102 can then store the packet content 112 for subsequent retransmission. For example, the sending device 102 can incorporate the packet content 112 into a data packet 128 that can be stored in the queue 114. The data packet 128 may be a new data packet or the original data packet 122 (e.g., if the original data packet 122 was encapsulated in the notification 116). Alternatively, the sending device 102 may store the packet content 112 in another storage location. Either way, by extracting and storing the packet content 112, the sending device 102 may be able to retransmit the packet content 112 in situations where it may not otherwise have the packet content 112 (e.g., if the packet content 112 was overwritten or deleted by the sending device 102 after sending the original data packet 122).

In some examples, the sending device 102 can eventually learn the current address 130 for the destination endpoint 106. For example, the sending device 102 can determine the current address 130 by extracting the current address 130 from the notification 116. Alternatively, the sending device 102 may eventually receive an announcement packet 120b indicating the location change of the destination endpoint 106. The announcement packet 120b may contain the current address 130 for the destination endpoint 106. The sending device 102 can extract the current address 130 from the announcement packet 120b.

After determining the current address 130 for the destination endpoint 106, the sending device 102 can retransmit the packet content 112 to that current address 130. For example, if the packet content 112 was stored in a data packet 128 in the queue 114, the sending device 102 can transmit the data packet 128 to the current address 130. The sending device 102 can also transmit any other data packets 118 in the queue 114 to the current address 130. Through this process, the packet content 112 and other data packets 118 can be successfully transmitted to the destination endpoint 106, despite the destination endpoint’s 106 changed location.

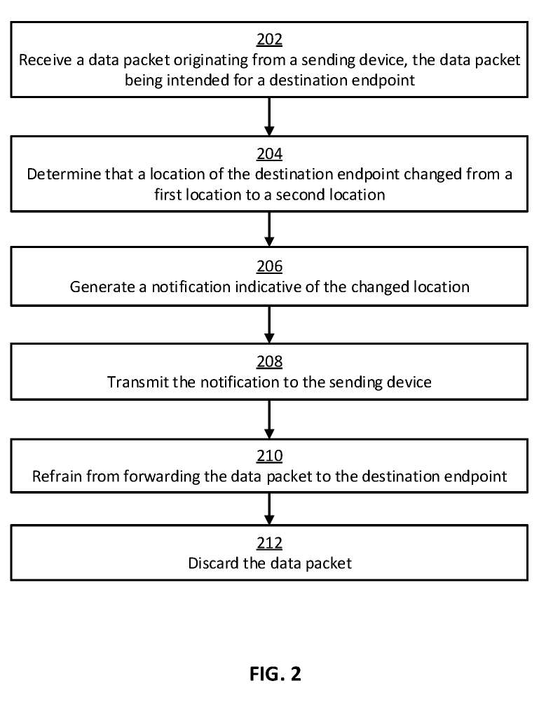

FIG. 2 shows a flowchart of a process implemented by a device 104 for reducing packet loss associated with endpoint location changes according to some aspects of the present disclosure. Other examples may involve more operations, fewer operations, different operations, or a different order of operations than is shown in FIG. 2. The operations of FIG. 2 are described below with reference to the components of FIG. 1 described above.

In block 202, a device 104 receives a data packet 122 originating from a sending device 102. The device 104 can receive the data packet 122 directly or indirectly from the sending device 102. The data packet 122 is intended for a destination endpoint 106. For example, the data packet 122 can include a destination address 124 that is associated with the destination endpoint 106. The destination address 124 may be associated with the destination endpoint 106 in that the destination address 124 may correspond to a prior location of the destination endpoint 106 (e.g., before a location change). The device 104 can receive the data packet 122 via one or more networks.

The destination endpoint 106 can be separate from and external to the device 104. For example, the destination endpoint 106 may reside at a different network location than the device 104. In some examples, the device 104 may be an intermediary device that is physically and/or logically positioned between the sending device 102 and the destination endpoint 106. Examples of the intermediary device may include a server or a network device, such as a router, hub, gateway, switch, or bridge.

In block 204, the device 104 determines that a location of the destination endpoint 106 changed from a first location 108 to a second location 110. The device 104 can determine that the endpoint’s location changed in any number of ways. For example, the device 104 can determine that the location changed based on an announcement packet 120a. As another example, the device 104 can determine that the location changed by communicating with the old (first) location 108 of the destination endpoint 106. For instance, the device 104 can communicate with the first location 108 to determine whether the destination endpoint 106 is still at the first location 108. If not, the device 104 can infer that the location of the destination endpoint changed – e.g., from the first location 108 to the second location 110. As yet another example, the device 104 can determine that the location changed by communicating with the new (second) location 110 of the destination endpoint 106. For instance, the device 104 can communicate with the second location 110 to determine whether the destination endpoint 106 is at the second location 110. If so, the device 104 can infer that the location of the destination endpoint changed – e.g., from the first location 108 to the second location 110.

In some examples, the device 104 can correspond to the old (first) location 108 of the destination endpoint 106. For instance, the device 104 may be a first host device on which the destination endpoint 106 existed prior to a migration to a second host device. In some such examples, the device 104 may determine the location changed based on its inherent awareness of the migration, or its inherent awareness that the destination endpoint 106 is no longer present on the device 104.

In block 206, the device 104 generates a notification 116 indicative of the changed location. For example, the notification 116 can indicate the location change through its content, such as a flag. The notification 116 may take the form of a data packet, in some examples.

The device 104 may incorporate at least some of the content from the data packet 122 into the notification 116. For example, the device 104 may encapsulate the data packet 122, in part or in full, in the notification 116. The device 104 may also include the current address 130 of the destination endpoint 106 into the notification 116, in some examples.

In block 208, the device 104 transmits the notification 116 to the sending device 102. For example, the device 104 can directly or indirectly transmit the notification 116 to the sending device 102 via one or more networks.

In block 210, the device 104 refrains from forwarding the data packet 122 to the destination endpoint 106 and/or another device in the computer network. For example, the device 104 may not send the data packet 122 to any other devices in the computer network.

In block 212, the device 104 discards the data packet 122. For example, the device 104 can delete the data packet 122 from memory.

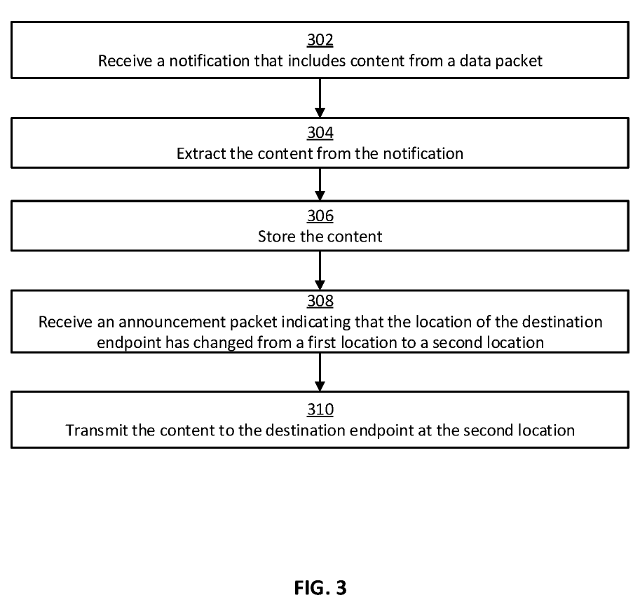

Turning now to FIG. 3, shown is a flowchart of an example of a process implemented by a sending device 102 for reducing packet loss associated with endpoint location changes according to some aspects of the present disclosure. Other examples may involve more operations, fewer operations, different operations, or a different order of operations than is shown in FIG. 3. The operations of FIG. 3 are described below with reference to the components of FIG. 1 described above.

In block 302, the sending device 102 receives a notification 116 that includes content 112 from a data packet 122. The data packet 122 may have been previously sent by the sending device 102. The sending device 102 can receive the notification 116 directly or indirectly from a device 104, which is separate from the sending device 102. The notification 116 can originate at the device 104. The sending device 102 can receive the notification 116 via one or more networks.

In block 304, the sending device 102 extracts the content 112 from the notification 116.

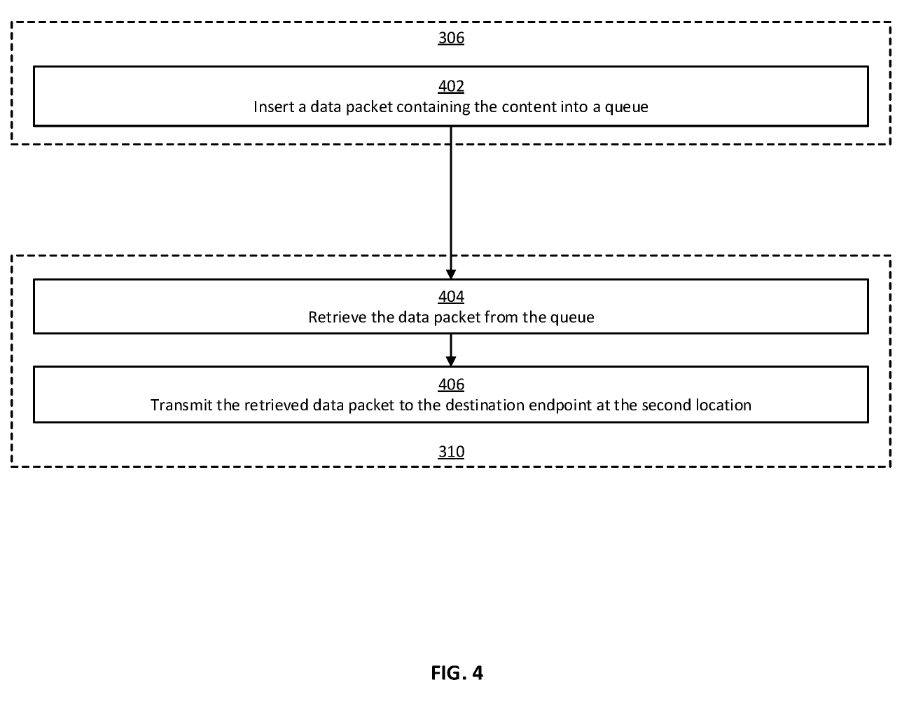

In block 306, the sending device 102 stores the content 112 in memory. For example, the sending device 102 can include the content 112 in a data packet 128. The data packet 128 can then be inserted into a queue 114, as shown in block 402 of FIG. 4.

In block 308, the sending device 102 receives an announcement packet 120b indicating that the location of the destination endpoint 106 changed – e.g., from a first location 108 to a second location 110. The sending device 102 can receive the announcement packet 120b from another component of the computer network, such as the device 104 or the destination endpoint 106.

The announcement packet 120b can originate from the destination endpoint 106 itself or its underlying host device. For example, the destination endpoint 106 or its underlying host device can generate the announcement packet 120b and transmit it to another device in the computer network. That device can then forward the announcement packet 120b to another device. And so on. In this way, the announcement packet 120b can propagate through various devices in the computer network until it eventually reaches the sending device 102.

In some examples, the announcement packet 120b can include the current address 130 of the destination endpoint 106. The sending device 102 can extract this information from the announcement packet 120b for use in subsequent data transmissions.

In block 310, the sending device 102 transmits the content 112 to the destination endpoint 106 at the second location 110. For instance, if the content 112 was stored in a data packet 128 in a queue 114, then the operations of blocks 404-406 of FIG. 4 may be performed, in which the sending device 102 retrieves the data packet 128 from the queue 114 and transmits the retrieved data packet 128 to the destination endpoint 106 at the second location 110. This may involve incorporating the current address 130 into a header of the data packet 128. On the other hand, if the content 112 was stored elsewhere in memory, the sending device 102 can retrieve the content 112 from memory, package it into a data packet (e.g., by incorporating the content 112 into the payload of the data packet), and transmit the data packet to the destination endpoint 106 at the second location 110. This may involve incorporating the current address 130 into a header of the data packet.

As noted earlier, in some examples, the operations of FIG. 3 may be reorganized and some may be excluded. For instance, in some cases, the sending device 102 may receive the announcement packet 120b (block 308) before receiving the notification 116 (block 302). In those circumstances, there may be no need to store a data packet 128 with the packet content 112 in the queue 114. Instead, the sending device 102 may simply generate the data packet 128 with the packet content 112 and transmit it to the destination endpoint 106 at the second location 110, without first queueing the data packet 128. Additionally, if the sending device 102 has not yet deleted the packet content 112 from its local memory when it receives the announcement packet 120b, it may use the locally stored packet content 112 for retransmission to the destination endpoint 106, rather than extracting the packet content 112 from the notification 116 (block 304). Various other alternatives will be apparent to those of ordinary skill in the art.

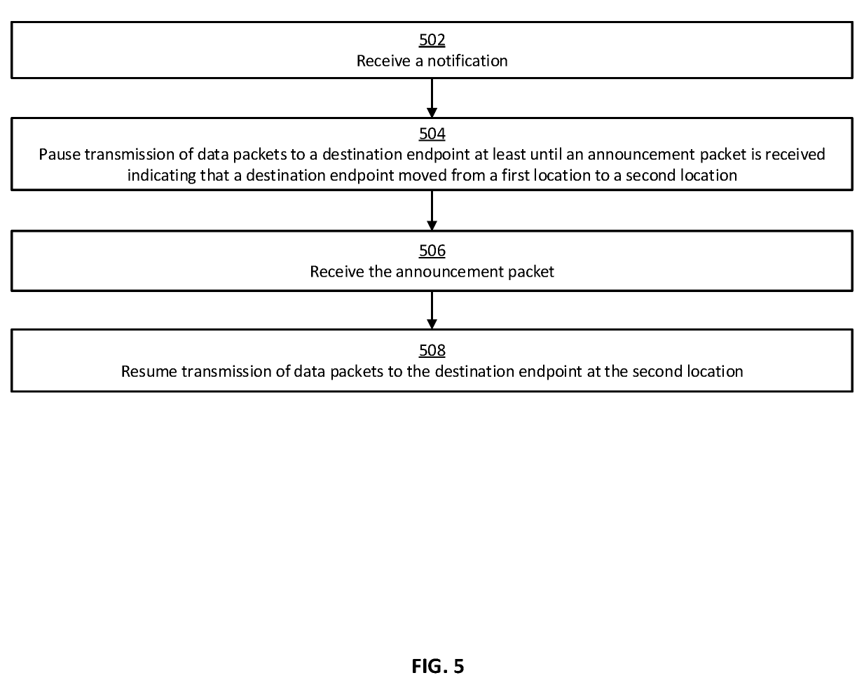

Turning now to FIG. 5, shown is a flowchart of another example of a process implemented by a sending device 102 for reducing packet loss associated with endpoint location changes according to some aspects of the present disclosure. Other examples may involve more operations, fewer operations, different operations, or a different order of operations than is shown in FIG. 5. The operations of FIG. 5 are described below with reference to the components of FIG. 1 described above.

In block 502, the sending device 102 receives a notification 116. The sending device 102 can receive the notification 116 directly or indirectly from a device 104, which is separate from the sending device 102. The notification 116 can originate at the device 104. The sending device 102 can receive the notification 116 via one or more networks.

The sending device 102 can receive the notification 116 from the device 104 after transmitting a data packet 122, which may have been received (e.g., intercepted) by the device 104. The notification 116 may include or exclude the content 112 of the data packet 122.

In block 504, the sending device 102 pauses transmission of data packets to a destination endpoint 106. The sending device 102 can pause the transmission of the data packets based on receiving the notification 116. The sending device 102 may pause the transmission of the data packets at least until an announcement packet 120b is received indicating that the destination endpoint 106 changed locations.

In block 506, the sending device 102 receives the announcement packet 120b. The sending device 102 can receive the announcement packet 120b from another component of the computer network, such as the device 104 or the destination endpoint 106. The announcement packet 120b can indicate that the destination endpoint 106 moved. In some examples, the announcement packet 120b may indicate the first location 108 and/or the second location 110 associated with the move.

In block 508, the sending device 102 resumes transmission of data packets to the destination endpoint 106 at the second location 110. The sending device 102 can resume transmission of data packets to the destination endpoint 106 based on receiving the announcement packet 120b.

As one example, the sending device 102 can transmit one or more of data packets to the destination endpoint 106 at the second location 110. These transmitted data packets can be different from the original data packet 122 that triggered the notification 116.

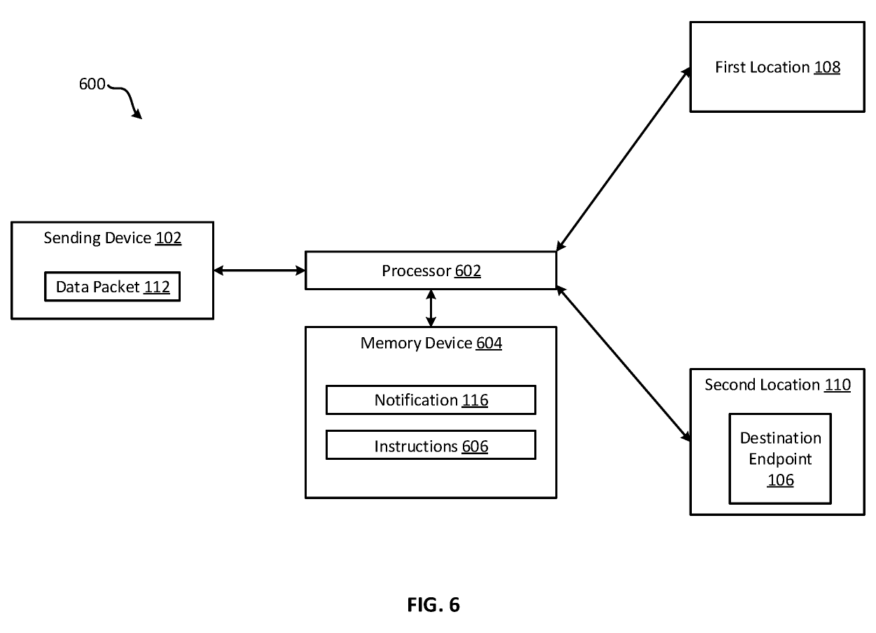

Turning now to FIG. 6, shown is a block diagram of an example of a system 600 for reducing packet loss associated with endpoint location changes according to some aspects of the present disclosure. The system 600 includes a processor 602 communicatively coupled to a memory 604. In some examples, the processor 602 and memory 604 may be included in a device, such as device 104 of FIG. 1.

The processor 602 can include one processing device or multiple processing devices. Non-limiting examples of the processor 602 include a Field-Programmable Gate Array (FPGA), an application-specific integrated circuit (ASIC), a microprocessor, or any combination of these. The processor 602 can execute instructions 606 stored in the memory 604 to perform operations, such as any of the operations described above with respect to the device 104. In some examples, the instructions 606 can include processor-specific instructions generated by a compiler or an interpreter from code written in any suitable computer-programming language, such as C, C++, C#, Python, or Java.

The memory 604 can include one memory device or multiple memory devices. The memory 604 can be volatile or non-volatile, such that the memory 604 retains stored information when powered off. Non-limiting examples of the memory 604 include electrically erasable and programmable read-only memory (EEPROM), flash memory, or any other type of non-volatile memory. At least some of the memory device can include a non-transitory computer-readable medium from which the processor 602 can read the instructions 606. A computer-readable medium can include electronic, optical, magnetic, or other storage devices capable of providing the processor 602 with computer-readable instructions or other program code. Non-limiting examples of a computer-readable medium can include magnetic disks, memory chips, ROM, random-access memory (RAM), an ASIC, a configured processor, optical storage, or any other medium from which a computer processor can read the instructions 606.

In some examples, the processor 602 can execute the instructions 606 to perform one or more operations. For example, the processor 602 can receive a data packet 122 over a network connection from a sending device 102, the data packet 122 being intended for a destination endpoint 106. The processor 602 can determine that a location of the destination endpoint 106 changed from a first location 108 to a second location 110. Based on receiving the data packet 122 and determining that the location of the destination endpoint 106 changed, the processor 602 can generate a notification 116 indicative of the location change. The processor 602 can then transmit the notification 116 to the sending device 102.

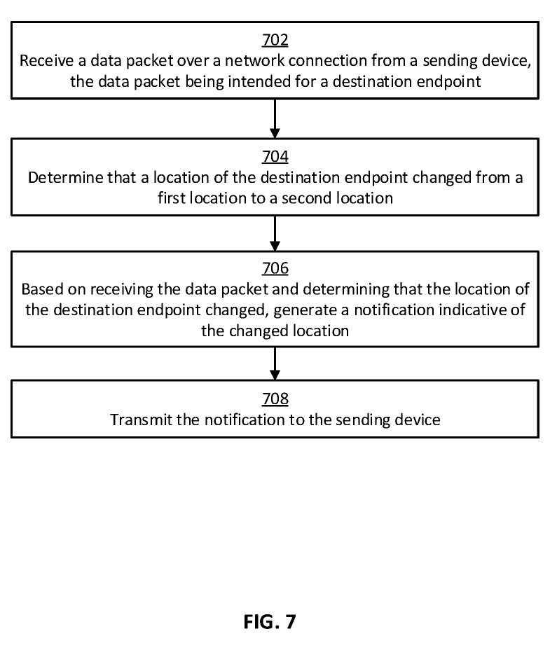

FIG. 7 shows a flowchart of a process for reducing packet loss associated with endpoint location changes according to some aspects of the present disclosure. Other examples may involve more operations, fewer operations, different operations, or a different order of operations than is shown in FIG. 7. The operations of FIG. 7 are described below with reference to the components of FIG. 6 described above.

In block 702, the processor 602 receives a data packet 122 over a network connection from a sending device 102, the data packet 122 being intended for a destination endpoint 106. This operation may be performed using any of the techniques described above, such as the techniques described in block 202 of FIG. 2.

In block 704, the processor 602 determines that a location of the destination endpoint 106 changed – e.g., from a first location 108 to a second location 110. This operation may be performed using any of the techniques described above, such as the techniques described in block 204 of FIG. 2.

In block 706, based on receiving the data packet 122 and determining that the location of the destination endpoint 106 changed, the processor 602 generates a notification 116 indicative of the location change. This operation may be performed using any of the techniques described above, such as the techniques described in block 206 of FIG. 2.

In block 708, the processor 602 transmits the notification 116 to the sending device 102. This operation may be performed using any of the techniques described above, such as the techniques described in block 208 of FIG. 2. The processor 602 may transmit the notification 116 directly or indirectly to the sending device 102. For example, the notification 116 may propagate through one or more additional devices in the computer network before reaching the sending device 102.

The foregoing description of certain examples, including illustrated examples, has been presented only for the purpose of illustration and description and is not intended to be exhaustive or to limit the disclosure to the precise forms disclosed. Numerous modifications, adaptations, and uses thereof will be apparent to those skilled in the art without departing from the scope of the disclosure. For instance, any examples described herein can be combined with any other examples to yield further examples.

1. A non-transitory computer-readable medium comprising program code that is executable by one or more processors of a device for causing the device to perform operations including:
receiving a data packet over a network connection from a sending device, the data packet being intended for a destination endpoint;
determining that a location of the destination endpoint changed from a first location to a second location;
based on receiving the data packet and determining that the location of the destination endpoint changed, generating a notification indicative of the location change; and
transmitting the notification to the sending device.

2. The non-transitory computer-readable medium of claim 1, wherein the notification includes content of the data packet.

3. The non-transitory computer-readable medium of claim 2, wherein the data packet is a first data packet, and wherein the sending device is configured to:
receive the notification;
based on receiving the notification, extract the content from the notification;
based on extracting the content from the notification, insert a second data packet that includes the content into a queue, wherein the second data packet is the same as or different from the first data packet;
after inserting the second data packet into the queue, receive an announcement packet indicating that the location of the destination endpoint has changed from the first location to the second location; and
in response to receiving the announcement packet:
retrieve the second data packet from the queue; and
transmit the retrieved second data packet to the destination endpoint at the second location.

4. The non-transitory computer-readable medium of claim 2, wherein the sending device is configured to:
receive an announcement packet indicating that the location of the destination endpoint has changed from the first location to the second location;
after receiving the announcement packet, receive the notification; and
based on receiving the announcement packet and the notification, extract the content from the notification and retransmit the content of the data packet to the destination endpoint at the second location.

5. The non-transitory computer-readable medium of claim 1, wherein the sending device is configured to:
receive the notification;
based on receiving the notification, pause transmission of data packets to the destination endpoint at least until an announcement packet is received indicating the destination endpoint moved from the first location to the second location;
subsequent to pausing the transmission of the data packets to the destination endpoint, receive the announcement packet; and
in response to receiving the announcement packet, transmit one or more data packets to the destination endpoint at the second location, wherein the one or more data packets are different than the data packet.

6. The non-transitory computer-readable medium of claim 1, wherein determining that the location of the destination endpoint changed from the first location to the second location involves:
determining whether the destination endpoint is still at the first location; and
in response to determining that the destination endpoint is no longer at the first location, inferring that the location of the destination endpoint changed from the first location to the second location.

7. The non-transitory computer-readable medium of claim 1, wherein the destination endpoint is a virtual machine or a container, the first location is a first host device and the second location is a second host device, and the second host device is different from the first host device.

8. The non-transitory computer-readable medium of claim 7, wherein the location of the virtual machine or the container changed as a result of a migration from the first host device to the second host device.

9. The non-transitory computer-readable medium of claim 1, wherein the first location is a first geographical location and the second location is a second geographical location.

10. The non-transitory computer-readable medium of claim 1, wherein the first location is a first logical location in a computer network and the second location is a second logical location in the computer network.

11. The non-transitory computer-readable medium of claim 1, wherein the device is a networking device, the networking device comprising a hub, a router, a bridge, a gateway, or a switch.

12. The non-transitory computer-readable medium of claim 1, wherein the operations further comprise:
based on determining that the location of the destination endpoint changed from the first location to the second location, refraining from forwarding the data packet to the destination endpoint and discarding the data packet.

13. A method comprising:
receiving, by one or more processors of a device, a data packet over a network connection from a sending device, the data packet being intended for a destination endpoint;
determining, by the one or more processors, that a location of the destination endpoint changed from a first location to a second location;
based on receiving the data packet and determining that the location of the destination endpoint changed, generating, by the one or more processors, a notification indicative of the location change; and
transmitting, by the one or more processors, the notification to the sending device.

14. The method of claim 13, wherein the notification includes content of the data packet.

15. The method of claim 14, wherein the data packet is a first data packet, and wherein the sending device is configured to:
receive the notification;
based on receiving the notification, extract the content from the notification;
based on extracting the content from the notification, insert a second data packet that includes the content into a queue, wherein the second data packet is the same as or different from the first data packet;
after inserting the second data packet into the queue, receive an announcement packet indicating that the location of the destination endpoint has changed from the first location to the second location; and
in response to receiving the announcement packet:
retrieve the second data packet from the queue; and
transmit the retrieved second data packet to the destination endpoint at the second location.

16. The method of claim 14, wherein the sending device is configured to:
receive an announcement packet indicating that the location of the destination endpoint has changed from the first location to the second location;
after receiving the announcement packet, receive the notification; and
based on receiving the announcement packet and the notification, extract the content from the notification and retransmit the content of the data packet to the destination endpoint at the second location.

17. The method of claim 13, wherein the sending device is configured to:
receive the notification;
based on receiving the notification, pause transmission of data packets to the destination endpoint at least until an announcement packet is received indicating the destination endpoint moved from the first location to the second location;
subsequent to pausing the transmission of the data packets to the destination endpoint, receive the announcement packet; and
in response to receiving the announcement packet, transmit one or more data packets to the destination endpoint at the second location, wherein the one or more data packets are different than the data packet.

18. The method of claim 13, wherein determining that the location of the destination endpoint changed from the first location to the second location involves:
determining whether the destination endpoint is still at the first location; and
in response to determining that the destination endpoint is no longer at the first location, inferring that the location of the destination endpoint changed from the first location to the second location.

19. The method of claim 13, further comprising:
based on determining that the location of the destination endpoint changed from the first location to the second location, discarding the data packet.

20. A system comprising:
one or more processors; and
one or more memories storing instructions that are executable by the one or more processors for causing the one or more processors to perform operations including:
receiving a data packet over a network connection from a sending device, the data packet being intended for a destination endpoint;
determining that a location of the destination endpoint changed from a first location to a second location;
based on receiving the data packet and determining that the location of the destination endpoint changed, generating a notification indicative of the location change; and
transmitting the notification to the sending device.
